(19) United States
(12) Patent Application Publication
(10) Pub. No.: US 2016/0257235 A1
(43) Pub. Date: Sep. 8, 2016

(54) Apparatus, System, and Method For A Skidding Assembly

(71) Applicant: Precision Surveillance Corporation, East Chicago, IN (US)

(72) Inventors: Christopher Cox, Valperaiso, IN (US); Paul Smith, Hinsdale, IL (US); Andrew Makinson, Crown Point, IN (US); David Maldonado, Homewood, IL (US)

(73) Assignee: PRECISION SURVEILLANCE CORPORATION, East Chicago, IN (US)

(21) Appl. No.: 14/640,200

(22) Filed: Mar. 6, 2015

(51) Int. Cl. B60P 1/02

(52) U.S. Cl. CPC B60P 1/02

(57) ABSTRACT

There is shown a skidding assembly having a pair of rail platforms. Each rail platform has a base member and a pair of boxed members spaced to form a gap there between. A pair of sawtooth racks are positioned adjacent the inside portions of the side boxed members. A pair of skid shoes are mounted over the upper walls of the boxed members and is configured to connect to a hydraulic cylinder system positioned in the gap between the boxed members. The hydraulic cylinder system includes movable cams that are able to adjust orientation to control the direction of travel of the skid shoes.

### FIELD OF THE INVENTION

The present invention relates to the moving a heavy structure or load laterally by a skidding assembly.

### BACKGROUND OF THE INVENTION

There are various apparatus, methods, and systems utilized today to move a heavy structure or load laterally. Generally two skidding assemblies push or pull the heavy structure or load laterally. These skidding assemblies or power-slide systems typically use a pair of parallel I-beams each with a skid shoe. The skid shoes, which supports the structure, are pulled or pushed along the beams.

In the prior art, there are two basic types of rig skidding assemblies. The first is the rack and pinion type. The second is the rod and piston type. The present invention falls in the second class of rig skidding systems. This type of system employs, for example, a hydraulic cylinder system having one end connected to the skid shoe. The opposite end of the cylinder system is configured to move in one direction. This allows the cylinder system to push or pull the skid shoes and thus the heavy structure or load.

The problem in the prior art is the ability to reverse the direction of the movement. Since the hydraulic cylinder systems are only capable of pushing or pulling the skid shoes in one direction, the ability to reverse the direction requires the hydraulic cylinder system to be removed and reinstalled on the opposite side of the heavy structure or load. There is no easy method or apparatus to reverse directions. As such there is a need to provide for a system, method, and apparatus that is configured to reverse the direction of travel of the skid shoes without the cumbersome and time consuming methods employed with the prior art.

### SUMMARY OF THE INVENTION

In one embodiment of the present invention there is provided a skidding assembly having a pair of rail platforms. Each rail platform includes a base member and a pair of side boxed members separately positioned on either side of the base member to form a gap there between. Each side boxed member includes at least an upper wall structure and an inner wall structure. A pair of sawtooth racks are separately positioned adjacent each of the inner wall structures of the pair of side boxed members. A pair of skid shoes having a pair of braces are positioned between the sawtooth racks. Each of the braces includes a notch. Each skid shoe includes a top plate configured to rest over the upper walls of the pair of side boxed members. A hydraulic cylinder system is positioned between the sawtooth rack and has a piston arm secured to a pin. The pin is positioned in the notches on one of the pair of skid shoes, which attaches the hydraulic cylinder system to a skid shoe. The hydraulic cylinder system further includes a pair of cams separately mounted to a side of a base of the hydraulic cylinder system. Each cam is movably secured to the base and the pair of cams have a first orientation configured to cause the hydraulic cylinder system to move the skid shoe in a first direction and further have a second orientation configured to cause the hydraulic cylinder system to move the skid shoe in a second direction.

The skidding assembly in accordance with other aspects of the embodiment may provide rail platforms that are configured to be positioned in parallel and at a predetermined distance form one another. In addition, the pair of side boxed members may be equally spaced apart about side edges defined by the base member.

The skidding assembly in accordance with other aspects of the embodiment may provide a sawtooth rack that has a plurality of repeating sawtooth jigs and has between each pair of adjacent sawtooth jigs a lateral flat portion. In other aspects, each of the sawtooth jigs may include a first portion that is curved inwardly towards one end that leads to a inclined portion, from the inclined portion the sawtooth jig may then include a declined portion that turns to a second portion that is curved outwardly towards an opposite end of the first portion.

In yet other aspects, each of the cams may include a profile defined to include a first end angled to ride over lips defined by the first or second portions of the sawtooth jigs and includes a curved second end configured to ride through the sawtooth jig and secure against either the first portion or second portion when the cam is oriented either in the first direction or second direction.

In addition, the skidding assembly may have an extension track positioned and secured to an end of the side boxed member such that a second rail platform similarly constructed can be positioned and secured end to end with the extension track.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of a skidding assembly in accordance with an embodiment of the present invention;

FIG. 2 is a top view of a rail platform used in the skidding assembly from FIG. 1;

FIG. 3 is a side view of the rail platform from FIG. 2;

FIG. 4 is a section view taken from section 4-4 in FIG. 3;

FIG. 5 is a section view taken from section 5-5 in FIG. 2;

FIG. 6 is a perspective view of a hydraulic cylinder illustrated in outline 6 from FIG. 1;

FIGS. 7A and 7B are views of an extension rack used to connect multiple rail platforms;

FIGS. 8A and 8B are views of a cam used in the hydraulic cylinder to control the direction of travel of the skid shoe;

FIGS. 9A and 9B are views of the skid shoe used in the skidding assembly and in accordance with an embodiment of the present invention;

FIG. 10 is a side view of the hydraulic cylinder illustrated with the cam positioned for a first direction of travel;

FIGS. 11A and 11B are side views of the sawtooth rack with the movement of the cam along the rack in various positions;

FIG. 12 is a side view of the hydraulic cylinder illustrated with the cam positioned for a second direction of travel; and

FIGS. 13A, 13B, 13C, and 13D are side views of the sawtooth rack with the movement of the cam along the rack in various positions.

### DETAILED DESCRIPTION OF THE DRAWINGS

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention of the embodiments illustrated.

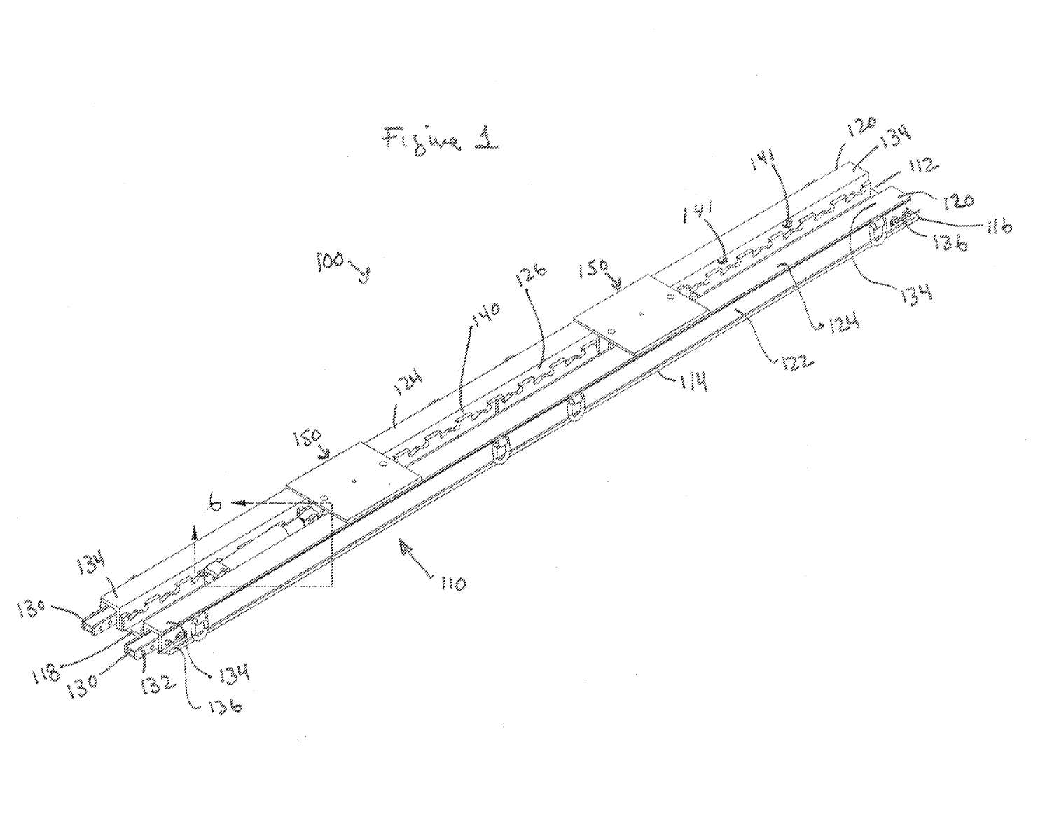

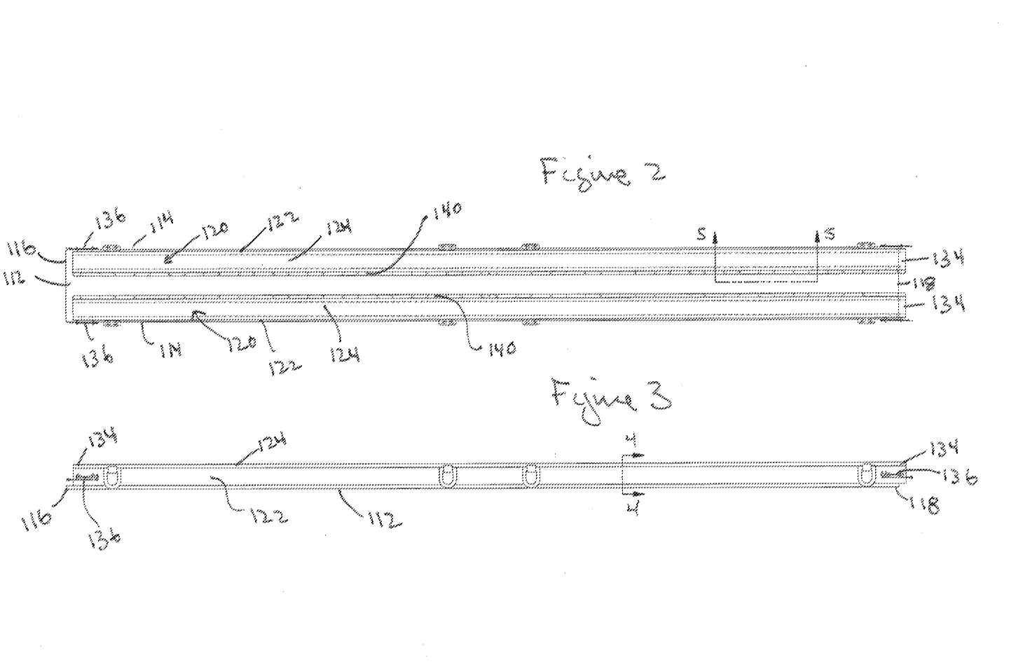

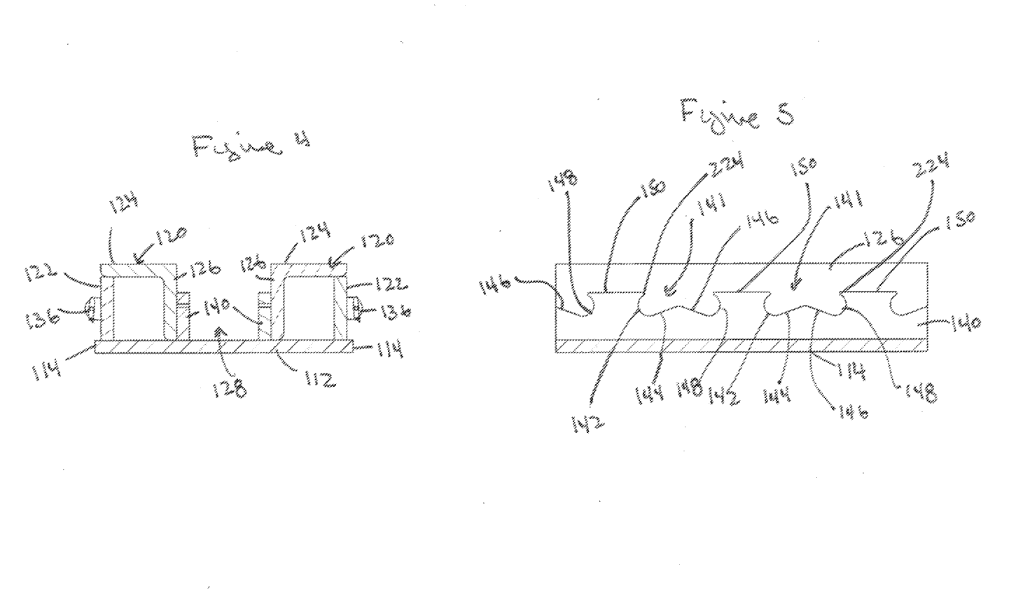

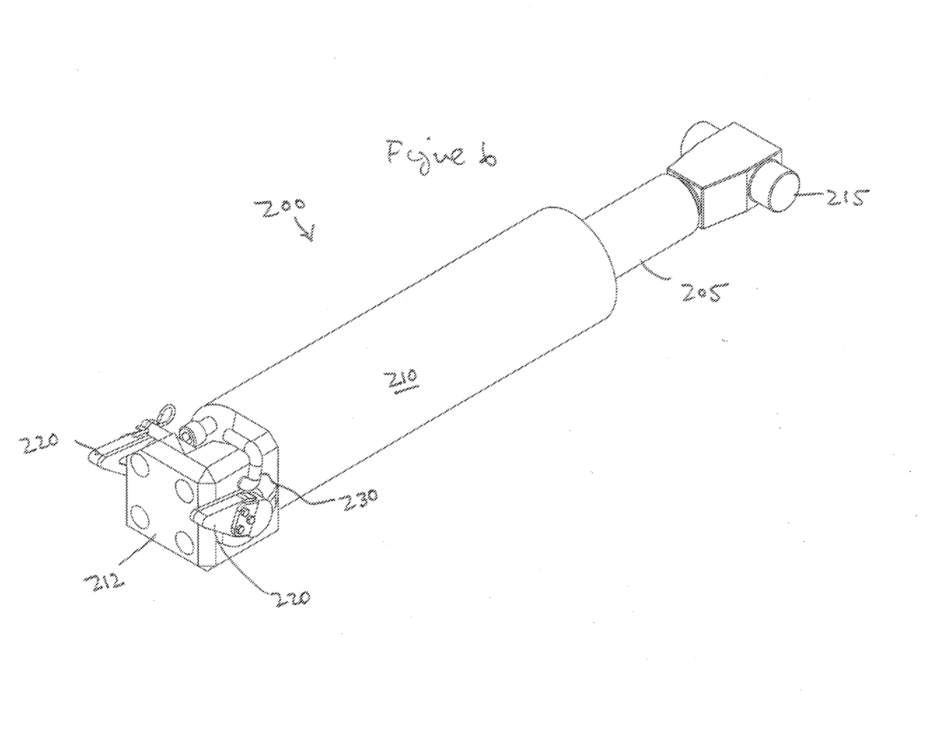

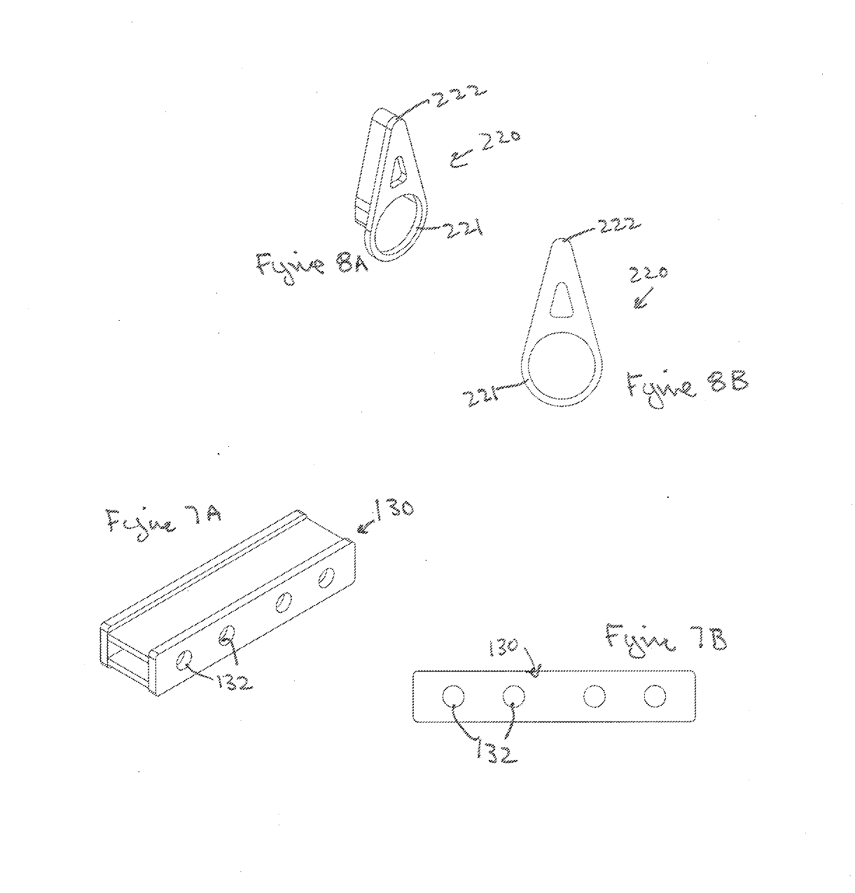

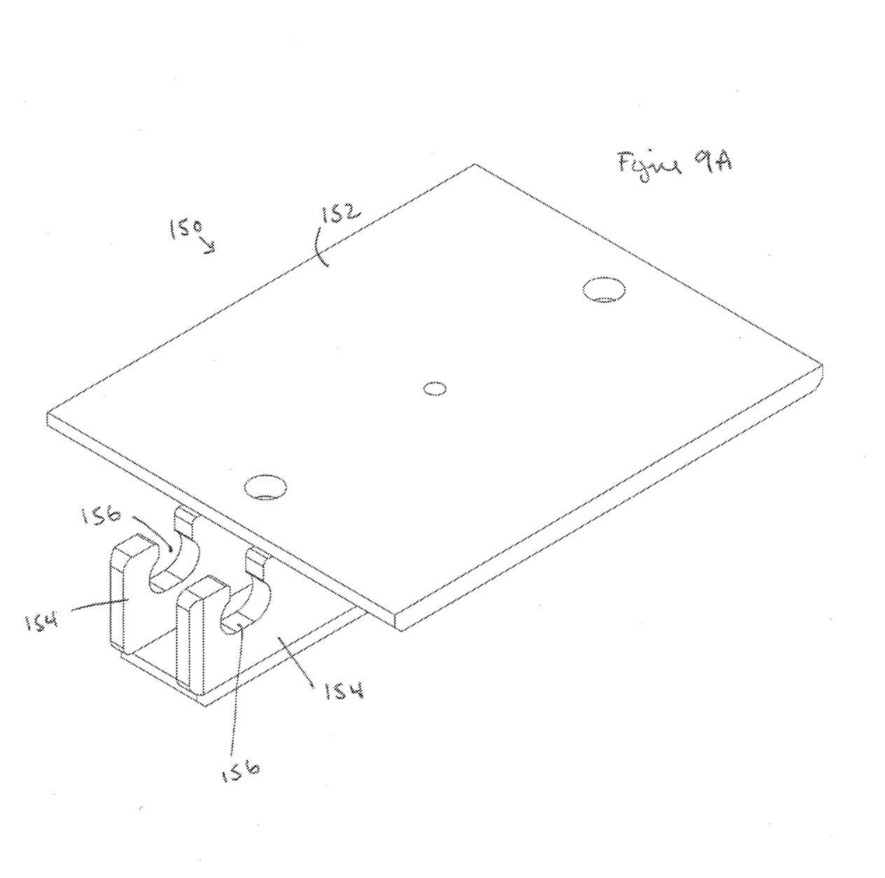

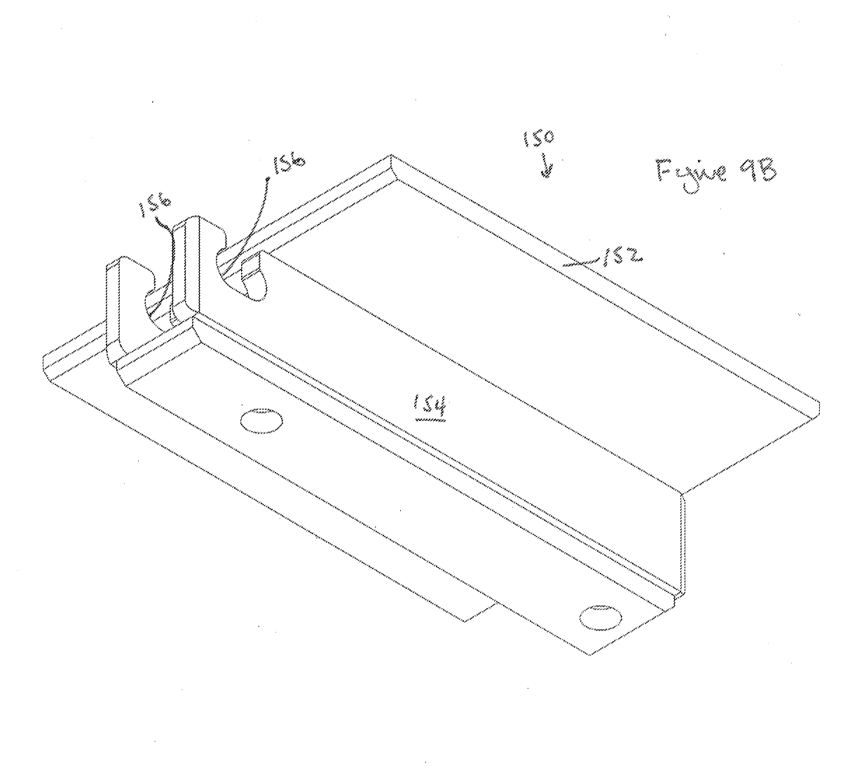

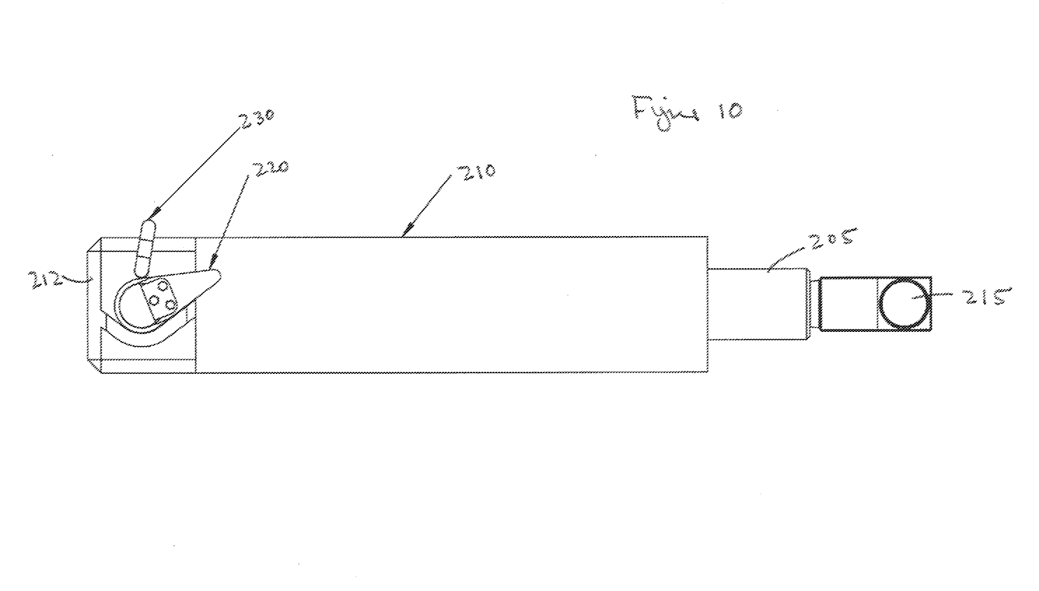

Referring now to FIGS. 1 through 13B there is shown a skidding assembly 100 used to move a heavy structure or load laterally. The skidding assembly 100 shown is used in conjunction with a duplicate assembly as a pair and are positioned in parallel at a predetermined distance apart.

Each skidding assembly 100 includes a rail platform 110 configured to include a base member 112 with a pair of side boxed members 120 equally spaced apart about the side edges 114 of the base member 112. Each side boxed member 120 includes an outer wall structure 122, an upper wall structure 124 and an inner wall structure 126. The side boxed members 120 are sized and positioned in a configuration that creates a gap 128 between the two and that causes the two inner wall structures 126 to face each other along the length of the base member 112. Along each of the inner wall structures 126 extending along the length of the side boxed members 120 and facing each other are sawtooth racks 140.

Each sawtooth rack 140 is made up of a repeating pattern of sawtooth jigs 141 that consists of a first portion 142 that is curved inwardly towards one end and which then leads to a inclined portion 144. The inclined portion flows into a declined portion 146 and which then ends into a second portion 148 that is curved outwardly towards an opposite end of the first portion 142. Between adjacent jigs 141 are lateral flats 150.

Positioned into each side boxed member about the ends thereof are extension tracks 130. The extension tracks 130 include apertures 132 that correspond to openings (not shown) along the ends 134 of each side boxed member 120. The extension tracks 130 can be locked into positioned by locking pins 136 that are inserted through the openings in the side boxed members 120 and into the apertures 132 of the extension tracks 130.

In addition, the base member 112 may have at one end a first lip edge 116 that extends past the pair of side boxed members and at the distal end a second lip edge 118 that ends prematurely such that the pair of side boxed members extend past the second lip edge 118. This permits a second set of skidding assemblies similarly constructed to be positioned against the first set with the first lip edge 116 being positioned under the side boxed members and rested against the second lip edge of the preceding set of skidding assemblies. Furthermore, the extension tracks 130 in the first set of skidding assemblies will insert into the side boxed members of the second set of skidding assemblies with the ability to lock the second set to the extension tracks 130 by positioning the locking pins 136.

Positioned along each rail platform 110 are a pair of skid shoes 150. Each skid shoe 150 includes a top plate 152 configured to rest over the pair of side boxed members 120. Secured under the top plate 152 are a pair of braces 154, which are positioned between the sawtooth racks 140 and which each of the braces include an undercut 156 on end thereof.

A hydraulic cylinder system 200 includes a piston arm 205 that is movable in relation to a housing 210 and which includes at one end a hydraulic pin 215 that rests in the undercut 156 of the braces of the skid shoe 150. The opposing end of the hydraulic cylinder system 200 includes a pair of cams 220 separately mounted to either side of the base 212 of the housing 210. Each cam 220 includes the profile of a tear drop which mounts into the sawtooth racks 140. As illustrated in the Figures, the cam 220 is slightly inclined such that the end 222 of its tear drop profile is angled to catch the lip 224 of the first or second portion 148 of the sawtooth jig when moving (as discussed below).

One aspect of the present invention is that the cams 220 are removable from the housing base by removing a retention pin 230 and which may then be reattached in the opposite direction. As noted below, once this occurs the hydraulic cylinder system 200 is immediately configured to move in the opposite direction.

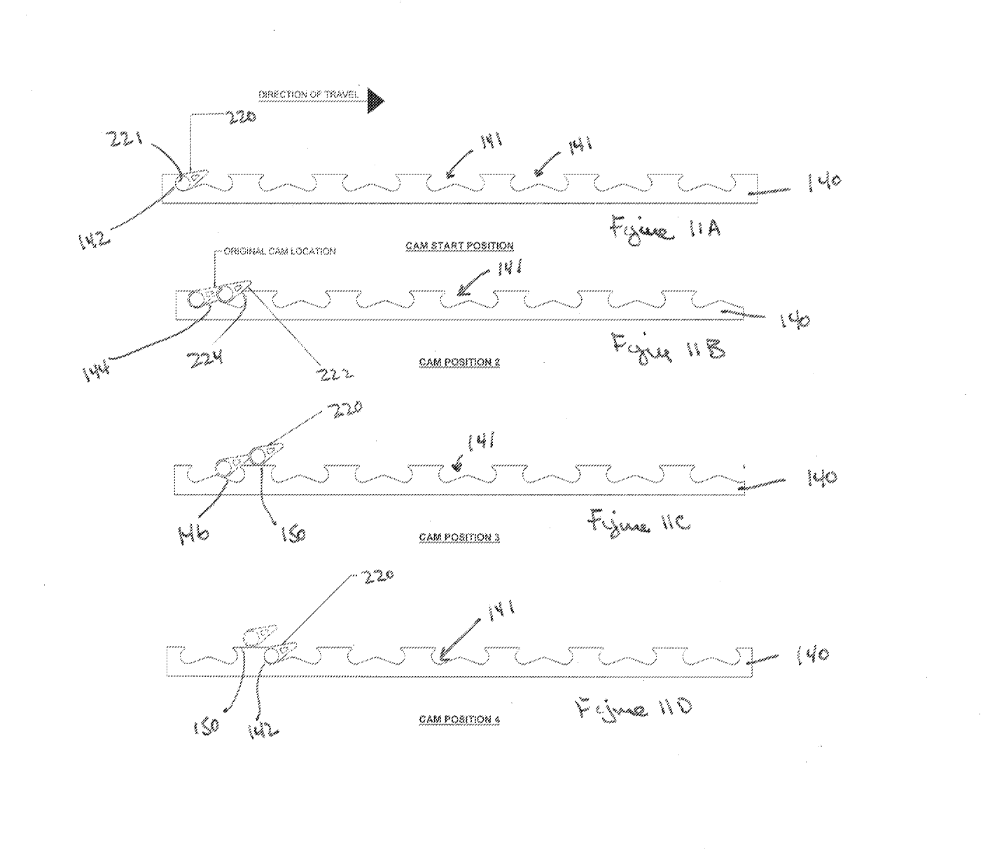

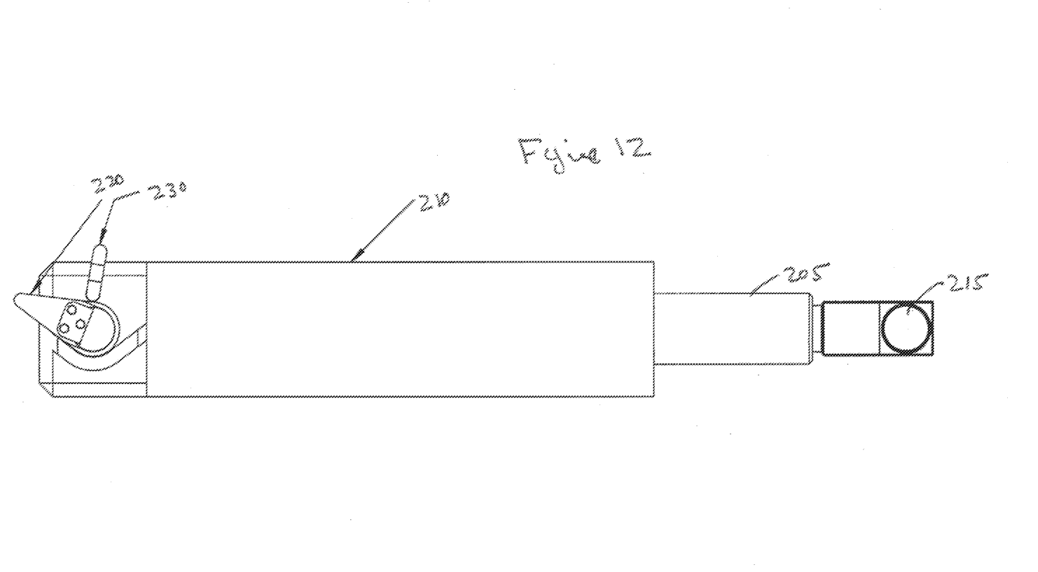

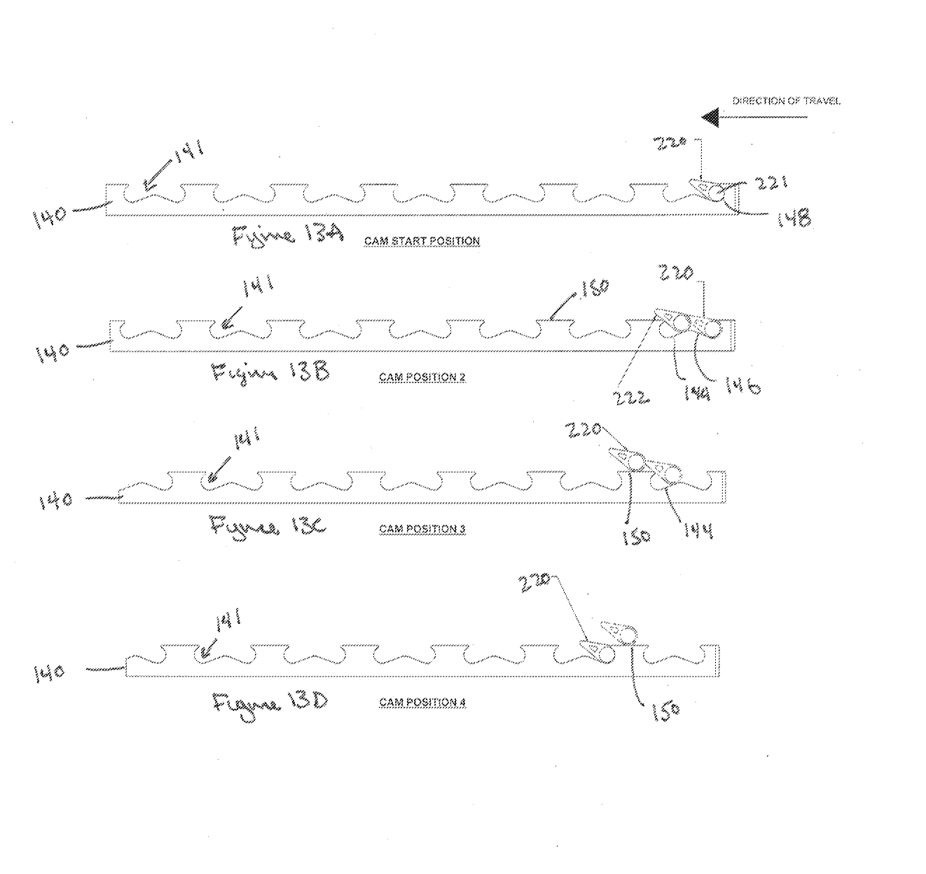

During operation, the cams 220 are positioned to indicate the direction of travel. The curved end 221 of the cams 220 are rested against the first portion 142 of the sawtooth jig 141. The hydraulic pin 215 is positioned in the undercut 156 of the braces of the skid shoe 150 and the heavy structure or load is resting on the top plate 152 of the skid shoe 150. With the curved end 221 of the cams 220 unable to move in the sawtooth jib, the hydraulic cylinder system 200 will push the skid shoe 150 outwardly from the cams 220 when the piston arm 205 extends from the housing. As the cylinder strokes in the cam is then pulled up and over the sawtooth jig. The cylinder continues to stroke in pulling the cam until it falls into the next sawtooth jib setting up cam in position for the process to continue. The heavy structure or load movement direction can be reversed by removing the retention pin in the cylinder housing, rotating the cam clockwise or counterclockwise depending on the orientation and re-inserting the retention pin. Further illustration of the movement is shown in FIGS. 11A-11D and 13A-13D. This eliminates the prior art systems of actually detaching and removing the hydraulic cylinder assembly and reattaching it on the other side of the skid shoe. This is a huge savings in time and effort, which reflects a savings in personnel expenses.

From the foregoing and as mentioned above, it is observed that numerous variations and modifications may be effected without departing from the spirit and scope of the novel concept of the invention. It is to be understood that no limitation with respect to the embodiments illustrated herein is intended or should be inferred. It is intended to cover, by the appended drawings provided, all such modifications within the scope of the invention.

We claim:

1. A skidding assembly comprising, a pair of rail platforms, each rail platform includes:
a base member;
a pair of side boxed members separately positioned on either side of the base member to form a gap there between, each side boxed member including at least an upper wall structure and an inner wall structure;
a pair of sawtooth racks separately positioned adjacent each of the inner wall structures of the pair of side boxed members;
a pair of skid shoes, each skid shoe having a top plate configured to rest over the upper walls of the pair of side boxed members and further having a pair of braces positioned between the sawtooth racks and secured to the top plate, each of the braces includes a notch;
a hydraulic cylinder system positioned between the sawtooth rack and having a piston arm secured to a pin, the pin being positioned in the notches on one of the pair of skid shoes, which attaches the hydraulic cylinder system to a skid shoe; and
a pair of cams separately mounted to a side of a base of the hydraulic cylinder system, each cam movably secured to the base and the pair of cams having a first orientation configured to cause the hydraulic cylinder system to move the skid shoe in a first direction and further having a second orientation configured to cause the hydraulic cylinder system to move the skid shoe in a second direction.

2. The skidding assembly of claim 1, wherein the rail platforms are configured to be positioned in parallel and at a predetermined distance form one another.

3. The skidding assembly of claim 1, wherein the pair of side boxed members are equally spaced apart about side edges defined by the base member.

4. The skidding assembly of claim 1, wherein each of the sawtooth racks comprising a plurality of repeating sawtooth jigs and wherein between each pair of adjacent sawtooth jigs is a lateral flat.

5. The skidding assembly of claim 4, wherein each of the sawtooth jigs includes a first portion that is curved inwardly towards one end that leads to a inclined portion, from the inclined portion the sawtooth jig then includes a declined portion that turns to a second portion that is curved outwardly towards an opposite end of the first portion.

6. The skidding assembly of claim 5, wherein each of the cams includes a profile defined to include a first end angled to ride over lips defined by the first or second portions of the sawtooth jigs and includes a curved second end configured to ride through the sawtooth jig and secure against either the first portion or second portion when the cam is oriented either in the first direction or second direction.

7. The skidding assembly of claim 1 further comprising an extension track positioned and secured to an end of the side boxed member such that a second rail platform similarly constructed can be positioned and secured end to end with the extension track.

8. The skidding assembly of claim 6, wherein the base member includes a first lip edge extending past the one end of the pair of side boxed members and includes a second lip edge ending prematurely such that a distal end of the pair of side boxed members extend past the second lip edge, whereby a second rail platform similarly constructed is able to fit such that the first lip edge slides under a portion of the end of the pair of side boxed members to rest adjacent a second lip edge.

9. A rail platform for use in a skidding assembly, the rail platform includes:
a base member;
a pair of side boxed members separately positioned on either side of the base member to form a gap there between, each side boxed member including at least an upper wall structure and an inner wall structure;
a pair of sawtooth racks separately positioned adjacent each of the inner wall structures of the pair of side boxed members;
at least one skid shoe, the skid shoe having a top plate configured to rest over the upper walls of the pair of side boxed members and further having a pair of braces positioned between the sawtooth racks and secured to the top plate, each of the braces includes a notch;
a hydraulic cylinder system positioned between the sawtooth rack and having a piston arm secured to a pin, the pin being positioned in the notches on the skid shoe, which attaches the hydraulic cylinder system to a skid shoe; and
a pair of cams separately mounted to a side of a base of the hydraulic cylinder system, each cam movably secured to the base and the pair of cams having a first orientation configured to cause the hydraulic cylinder system to move the skid shoe in a first direction and further having a second orientation configured to cause the hydraulic cylinder system to move the skid shoe in a second direction.

10. The skidding assembly of claim 9, wherein the pair of side boxed members are equally spaced apart about side edges defined by the base member.

11. The skidding assembly of claim 9, wherein each of the sawtooth racks comprising a plurality of repeating sawtooth jigs and wherein between each pair of adjacent sawtooth jigs is a lateral flat.

12. The skidding assembly of claim 11, wherein each of the sawtooth jigs includes a first portion that is curved inwardly towards one end that leads to a inclined portion, from the inclined portion the sawtooth jig then includes a declined portion that turns to a second portion that is curved outwardly towards an opposite end of the first portion.

13. The skidding assembly of claim 12, wherein each of the cams includes a profile defined to include a first end angled to ride over lips defined by the first or second portions of the sawtooth jigs and includes a curved second end configured to ride through the sawtooth jig and secure against either the first portion or second portion when the cam is oriented either in the first direction or second direction.

14. The skidding assembly of claim 9 further comprising an extension track positioned and secured to an end of the side boxed member such that a second rail platform similarly constructed can be positioned and secured end to end with the extension track.

15. The skidding assembly of claim 14, wherein the base member includes a first lip edge extending past the one end of the pair of side boxed members and includes a second lip edge ending prematurely such that a distal end of the pair of side boxed members extend past the second lip edge, whereby a second rail platform similarly constructed is able to fit such that the first lip edge slides under a portion of the end of the pair of side boxed members to rest adjacent a second lip edge.

16. A skidding assembly having a pair of rail platforms, each of the rail platforms having a base member and a pair of boxed members spaced to form a gap there between, a pair of sawtooth racks positioned adjacent inside portions of the side boxed members such that the sawtooth racks face each other, a skid shoe mounted over upper walls of the boxed members and configured to connect to a hydraulic cylinder system positioned in the gap between the boxed members, the hydraulic cylinder system includes movable cams that ride in the sawtooth racks and the cams are configured to adjust orientation to control the direction of travel of the skid shoe.

17. The skidding assembly of claim 16, wherein each of the sawtooth racks comprising a plurality of repeating sawtooth jigs and wherein between each pair of adjacent sawtooth jigs is a lateral flat portion, and wherein each of the sawtooth jigs includes a first portion that is curved inwardly towards one end that leads to a inclined portion, from the inclined portion the sawtooth jig then includes a declined portion that turns to a second portion that is curved outwardly towards an opposite end of the first portion.

18. The skidding assembly of claim 16, wherein each of the cams includes a profile defined to include a first end angled to ride over lips defined by the first or second portions of the sawtooth jigs and includes a curved second end configured to ride through the sawtooth jig and secure against either the first portion or second portion when the cam is oriented either in the first direction or second direction.
